(19) United States
(12) Patent Application Publication
(10) Pub. No.: US 2010/0307673 A1
(43) Pub. Date: Dec. 9, 2010

(54) Method of manufacturing blood-pressure cuff

(75) Inventor: Kenichi Matsumoto, Morioka-shi (JP)

Correspondence Address: WENDEROTH, LIND & PONACK, L.L.P., 1030 15th Street, N.W.,, Suite 400 East, Washington, DC, 20005-1503, US

(73) Assignee: CITIZEN SYSTEMS JAPAN CO., LTD.

(21) Appl. No.: 12/801,334

(22) Filed: Jun. 3, 2010

(30) Foreign Application Priority Data
Jun. 9, 2009 (JP) 2009-138621

(51) Int. Cl. B32B 38/10

(52) U.S. Cl. 156/253

(57) ABSTRACT

A method of manufacturing a blood-pressure cuff having a fluid bag which expands in a state in which fluid is supplied inside and contracts in a state in which the fluid is removed, the blood-pressure cuff being wound around a subject, includes the steps of: overlapping a first member which becomes a first bag and a second member which becomes a second bag; joining the two members in a region having an area smaller than an area of the overlapped region; forming an opening which is common to the two members by cutting out a range surrounded by an entire portion or a part of the joined region; and forming the fluid bag in which the first bag and the second bag are joined by forming the first member into the first bag and the second member into the second bag.

### PRIORITY CLAIM

The present application is based on and claims priority from Japanese Patent Application No. 2009-138621, filed on Jun. 9, 2009, the disclosure of which is hereby incorporated by reference in its entirety.

### BACKGROUND OF THE INVENTION

1. Field of the Invention

The present invention relates to a method of manufacturing a blood-pressure cuff, more particularly, to an improvement in a method of manufacturing a fluid bag for use in a cuff.

2. Description of the Related Art

A blood-pressure monitor which measures blood pressure of a subject measures a pressure of blood flow in a blood vessel of an upper arm, a wrist and the like of a subject. The measurement of this pressure of the blood flow is performed by compressing a measurement portion of an upper arm, a wrist and the like so as to stop the blood flow, and detecting the pulsation of the blood flow while gradually easing the compression.

In order to compress the measurement portion, a cuff having a fluid bag is used. The fluid bag expands in a state in which fluid such as air is supplied inside thereof and contracts in a state in which this fluid is removed from the inside.

More specifically, when measuring blood pressure of a subject, the cuff is wrapped around a measurement portion, and the measurement portion is compressed by expanding the fluid bag, the compression of the measurement portion is eased by gradually contracting the fluid bag, and then the value of the blood pressure is obtained according to the pressure inside the fluid bag corresponding to a pulsation condition detected in this process.

Meanwhile, the cuff is wrapped around the measurement portion in a state in which the fluid bag is contracted. However, if the fluid bag is expanded in the measurement of the blood pressure, the fluid bag is displaced from the measurement portion due to the change in the shape of the fluid bag, so that the measurement portion can not be appropriately compressed.

Consequently, there has been proposed a fluid bag having a structure in which the fluid bag is hardly displaced from a measurement portion even if it is expanded.

For example, JP3452016B and JP37479178 propose a double-layered fluid bag in which two fluid rooms which communicate with each other inside are stacked in layers. JP2003-144398A also proposes a fluid bag in which the gore in the thickness direction (the radial direction when the cuff is wrapped around the measurement portion) is formed in a bellows shape. According to these arts, the displacement in the direction along the central axis of an upper arm and a wrist when the fluid bag is expanded can be controlled while securing a margin for expanding in the radial direction (the stacking direction of the fluid bag) when the cuff is wrapped around the measurement portion.

However, the fluid bags proposed in the above-described arts have complex structures, so that a number of components and man-hours are required for manufacturing; thus, it is difficult to control the manufacturing costs.

### SUMMARY OF THE INVENTION

The present invention has been made in view of the above circumstances, and is aimed to provide a method of manufacturing a blood pressure cuff which can manufacture with a simple process a single fluid bag in which two fluid rooms communicate with each other.

In order to achieve the above object, the present invention provides a method of manufacturing a blood-pressure cuff including the steps of joining two members which become bags later, respectively, forming in the joined portion an opening which communicates both of the bags with each other, and forming both of the members into the bags, respectively.

### BRIEF DESCRIPTION OF THE DRAWINGS

The accompanying drawings are included to provide further understanding of the invention, and are incorporated in and constitute a part of this specification. The drawings illustrate an embodiment of the invention and, together with the specification, serve to explain the principle of the invention.

FIGS. 1A, 1B are views each illustrating one example of a blood-pressure cuff manufactured by a method of manufacturing a blood-pressure cuff according to an embodiment of the present invention; FIG. 1A provides a perspective view illustrating a schematic structure, FIG. 1B illustrates a condition in which the blood-pressure cuff is wrapped around an upper arm (measurement portion) of a human body (subject).

FIGS. 2A, 2B, 2C are views (Part 1) each illustrating a process of manufacturing the cuff illustrated in FIG. 1 according to Embodiment 1; FIG. 2A illustrates a process of overlapping sheet-like members, FIG. 2B illustrates a process of welding the sheet-like members and forming an opening, FIG. 2C illustrates a process of forming each sheet-like member into a tube-like body.

FIGS. 3A, 3B, 3C are views (Part 2) each illustrating a process of manufacturing the cuff illustrated in FIG. 1 according to Embodiment 1; FIG. 3A illustrates a process of welding opposite side portions in order to maintain the configuration formed into the two tube-like bodies, FIG. 3B illustrates a process of crushing both end portions of each tube-like body, FIG. 3C illustrates a process of welding both the crushed end portions and forming into bags.

FIGS. 4A, 4B, 4C are views (Part 1) each illustrating a process of Modified Example 1 in Embodiment 1; FIG. 4A illustrates a process of overlapping sheet-like members, FIG. 4B illustrates a process of welding the sheet-like members, and forming an opening, FIG. 4C illustrates a process of forming each sheet-like member into a tube-like body.

FIGS. 5A, 5B are views (Part 2) each illustrating a process of Modified Example 1 in Embodiment 1; FIG. 5A illustrates a process of welding opposite side portions in order to maintain a configuration formed into two tube-like bodies, FIG. 5B illustrates a process of crushing both end portions of each tube-like body, welding the crushed both end portions and forming bags.

FIGS. 6A, 6B, 6C are views (Part 1) each illustrating a process of Modified Example 2 in Embodiment 1; FIG. 6A illustrates a process of overlapping sheet-like members, FIG. 6B illustrates a process of welding both sheet-like members and forming an opening, FIG. 6C illustrates a process of forming each sheet-like member into a tube-like body.

FIGS. 7A, 7B are views (Part 2) each illustrating a process of Modified Example 2 in Embodiment 1; FIG. 7A illustrates a process of welding opposite side portions in order to maintain a configuration formed into two tube-like bodies, FIG. 7B illustrates a process of crushing both end portions of each cylindrical body, welding the crushed both end portions and forming into bags.

FIGS. 8A, 8B, 8C are views (Part 1) each illustrating a process of Modified Example 3 of Embodiment 1; FIG. 8A illustrates a sheet-like first member and a tube-like second member, FIG. 8B illustrates a process of overlapping the tube-like second member and the sheet-like first member, FIG. 8C illustrates a process of applying a load which presses both of the members.

FIGS. 9A, 9B, 9C are views (Part 2) each illustrating a process of Modified Example 3 in Embodiment 1; FIG. 9A illustrates a process of welding both members, FIG. 9B illustrates a process of forming an opening in the welded portion, FIG. 9C illustrates a process of forming each member into a bag.

FIGS. 10A, 10B are views (Part 1) each illustrating a process of manufacturing the cuff illustrated in FIG. 1 according to Embodiment 2; FIG. 10A is a view illustrating two tube-like bodies, FIG. 10B illustrates a process of forming double tubc-likc bodies by inserting one tube-like body into the other tube-like body.

FIGS. 11A, 11B, 11C are views (Part 2) each illustrating a process of manufacturing the cuff illustrated in FIG. 1 according to Embodiment 2. FIG. 11A illustrates a process of welding double tube-like bodies and forming an opening, FIG. 11B illustrates a process of pulling out the outside tube-like body from the inside tube-like body while turning over the outside tube-like body, FIG. 11C illustrates a configuration having the inside tube-like body and the turned over outside tube-like body.

FIGS. 12A, 12B are views (Part 1) each illustrating a process of Modified Example 4 in Embodiment 2; FIG. 12A illustrates two tube-like bodies, FIG. 12B illustrates a process of forming double tube-like bodies by inserting one tube-like body into the other tube-like body.

FIGS. 13A, 13B, 13C are views (Part 2) each illustrating a process of Modified Example 4 in Embodiment 2; FIG. 13A illustrates a process of welding the double tube-like bodies and forming an opening, FIG. 13B illustrates a process of pulling out via the opening the inside tube-like body from the outside tube-like body while turning over the inside tube-like body, FIG. 13C illustrate a configuration having the outside tube-like body and the turned over inside tube-like body.

### DETAILED DESCRIPTION OF THE PREFERRED EMBODIMENT

Hereinafter, embodiments of a method of manufacturing a blood-pressure cuff will be described with reference to the accompanying drawings.

### Embodiment 1

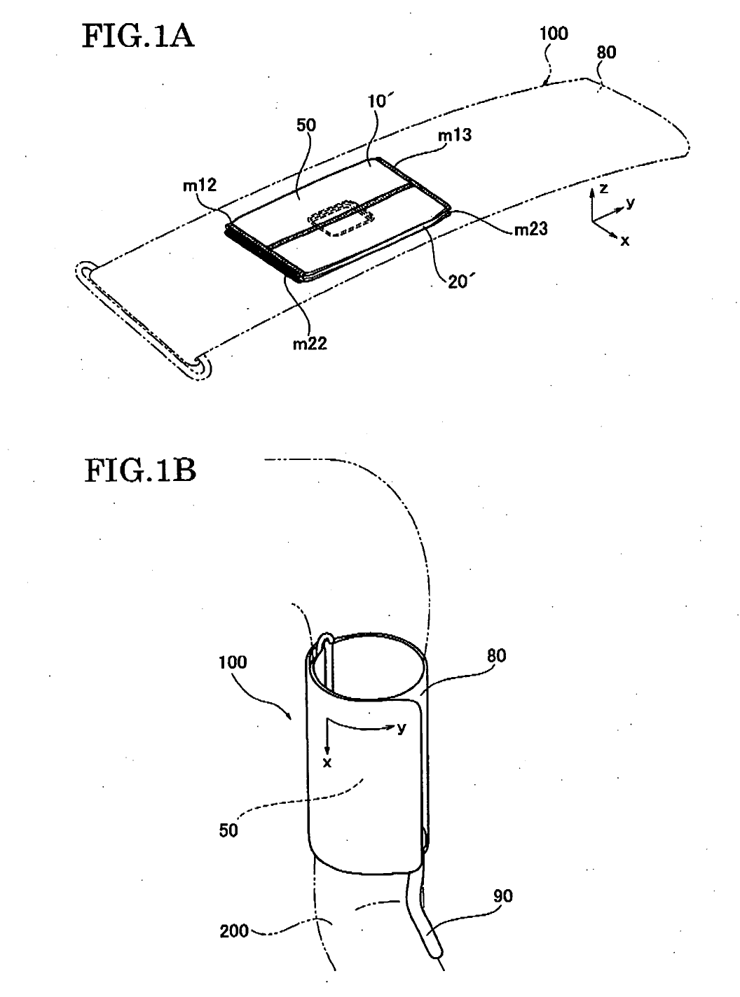

FIG. 1A is a perspective view illustrating a substantial part of a blood-pressure cuff 100 (hereinafter, cuff 100) manufactured by a method of manufacturing a blood-pressure cuff according to one embodiment of the present invention. This cuff 100 includes a cuff body 80 illustrated by a two-point chained line and a fluid bag 50 housed inside the cuff body 80.

As illustrated in FIG. 1B, this cuff 100 is wrapped around a measurement portion (upper arm portion in FIG. 1B) of a subject 200 in a state in which the fluid bag 50 is contracted (in a state in which fluid such as air is not supplied inside). Air (fluid) is supplied inside the fluid bag 50 via a not shown connector (joint) to which an air hose 90 is connected, so that the fluid bag 50 is expanded. By expanding the fluid bag, the compression of the measurement portion is increased, and the compression of the measurement portion is eased in a state in which the inside air is removed via the connector.

The illustrated fluid bag 50 is integrally formed by overlapping a first bag 10′ and a second bag 20′ in the thickness direction (z-axis direction) of the cuff 100. In a state in which the cuff 100 is wrapped around the measurement portion of the subject 200 (refer to FIG. 1B), the first bag 10′ is located on a side (outer circumferential side) far from the measurement portion of the subject 200 and the second bag 20′ is located on a side (inner circumferential side) close to the measurement portion of the subject.

The cuff 100 has a long, thin rectangular shape in which the length in the y-axis direction is longer than the length in the x-axis direction in the x-y plane of coordinates as illustrated in FIG. 1A. As illustrated in FIG. 1B, the x-axis direction corresponds to the width direction relative to the measurement portion and the y-axis direction corresponds to the wrapping direction relative to the measurement portion.

In FIG. 1A, reference numbers m12, m13, m22, m23 denote the after-mentioned welded portions.

Next, a method of manufacturing the above fluid bag 50 will be described. According to the method of manufacturing the fluid bag 50, basically, the two members (a first member 10 and a second member 20) which later become the bags 10′, 20′, respectively, are joined in advance, and an opening W which communicates both of the bags 10′, 20′ with each other when later formed in the bags 10′, 20′ is formed in the joined portion. After that, by forming both of the members 10, 20 as the bags 10′, 20′, respectively, the single fluid bag 50 in which the two fluid rooms (the inside spaces of the bags) communicate with each other is obtained.

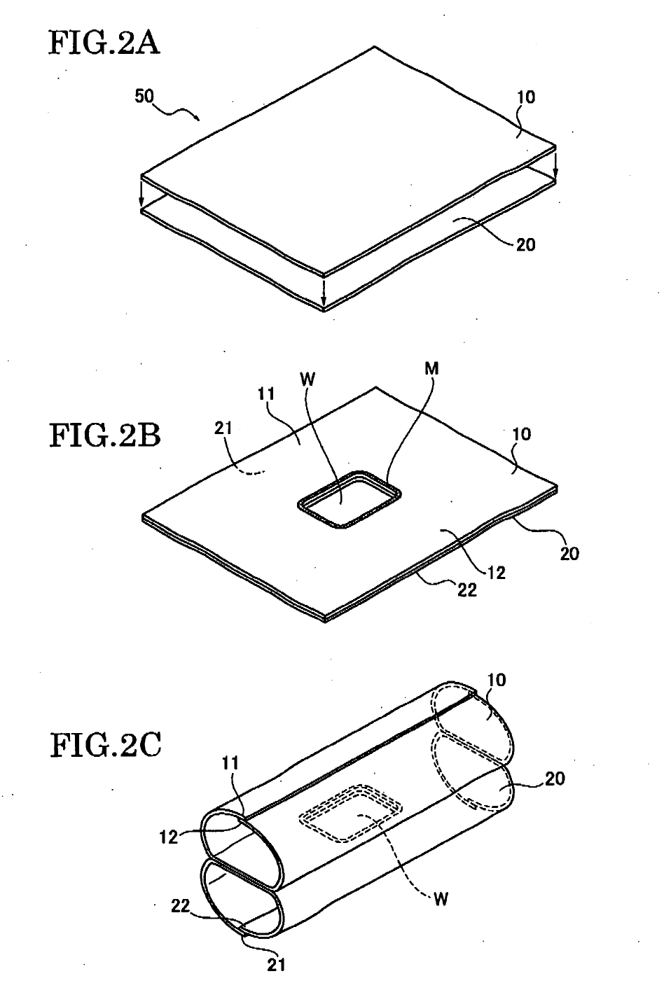

Namely, as illustrated in FIG. 2A, at first, the rectangular sheet-like first member 10 (sheet-like member) which becomes the first bag 10′ later is overlapped onto the rectangular sheet-like second member 20 (sheet-like member) which becomes the second bag 20′ later.

In this case, the first and second members 10, 20 are made of a material having air leakage efficiency and flexibility. The sizes of both members 10, 20 can be the same, or one member can be larger than the other member. When the sizes of both members 10, are different, it is not necessary for both members 10, 20 to be similar shapes.

As illustrated in FIGS. 1A, 1B, when the cuff 100 is wrapped around the measurement portion of the subject 200, the first bag 10′ is placed on the outer circumferential side and the second bag 20′ is placed on the inner circumferential side. Therefore, when the angle range of the wrapping of the fluid bag 50 about the central axis of the measurement portion to which the cuff 100 is wrapped is set to be the same between the inner circumferential side (the second bag 20′) and the outer circumferential side (the first bag 10′), it is necessary to set the length of the outer circumferential side longer than the length of the inner circumferential side. Therefore, the size of the first member 10 is increased so as to be larger than the size of the second member 20 such that the first bag 10′ becomes larger than the second bag 20′.

In the following description, the sizes of both members 10, 20 are the same.

As illustrated in FIG. 2A, the corner portions and the side edges of the first member 10 and the second member 20 are aligned. After both members 10, 20 are overlapped, the two members 10, 20 are welded (joined) in a region (for example, a rectangular region in the central portion of the first and second members 10, 20) having an area (an area smaller than the area of the first member or the area of the second member) which is smaller than the area of the overlapped region in the overlapped region (the entire surface of the first member 10 or the enter surface of the second member 20) as illustrated in FIG. 2B.

In addition, the rectangular outline portion illustrated by minute dots in the figure is the welded portion M (welded region). The welded portion M is a portion welded by heat and the like, but a joining process using an adhesive material and the like can be applied instead of the welding process as long as an air sealing performance in the joined region is ensured.

After that, the inside range surrounded by the welded portion M is cut out so as to form an opening W which is common to the two members 10, 20 (FIG. 2B).

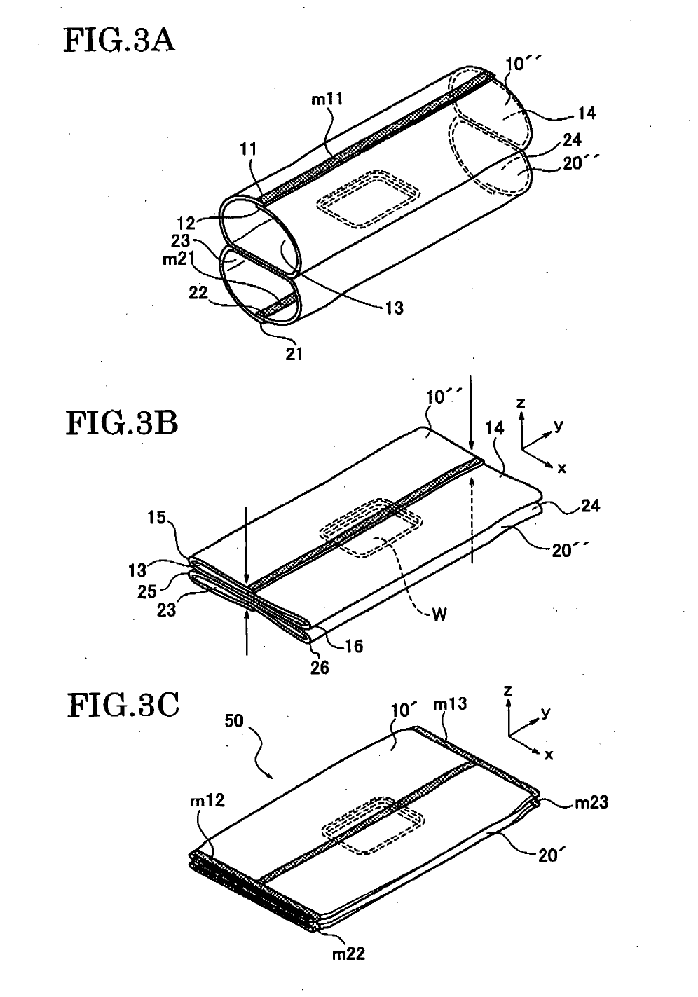

Next, opposite sides 11, 12 of the first sheet-like member as the first member 10 are overlapped (FIG. 2C), and the overlapped opposite sides 11, 12 are welded so as to form a first tube-like body 10″ (FIG. 3A).

Similarly, opposite sides 21, 22 of the second sheet-like member as the second member 20 are overlapped (FIG. 2C), and the overlapped opposite sides 21, 22 are welded so as to form a second tube-like body 20″ (FIG. 3A).

In this case, the joined opposite sides 21, 22 of the second sheet-like member are side portions which overlap with the joined opposite sides 11, 12 of the first sheet-like member. Both of the tube-like bodies 10″, 20″ are formed such that both of the axes become parallel to each other.

In addition, in FIG. 3A, reference number m11 denotes the welded portion of the opposite sides 11, 12, and reference number m21 denotes the welded portion of the opposite sides 21, 22.

Next, both end portions 13, 14 of the first tube-like body 10″ in the axis direction (the direction along the axis of the tube-like body; the direction along the y-axis in the figure) are deformed to be crushed in the radial direction (the direction along the z-axis in the figure) of the tube-like body as illustrated in FIG. 3B, and the side portions are overlapped. The overlapped end portions 13, 14 are joined, respectively, as illustrated in FIG. 3C, and the openings of both end portions 13, 14 of the first tube-like body 10″ are closed, respectively, so that the first bag 10′ is formed.

Similarly, both end portions 23, 24 of the second tube-like body 20″ in the axis direction (the direction along the axis of the tube-like body; the direction along the y-axis direction in the figure) are deformed to be crushed in the radial direction (the direction along the z-axis in the figure) of the tube-like body as illustrated in FIG. 3B, and the side portions are overlapped. The overlapped end portions 23, 24 are joined, respectively, as illustrated in FIG. 3C, and the openings of both end portions 23, 24 of the second tube-like body 20″ are closed, respectively, so that the second bag 20′ is formed.

In FIG. 3C, reference number m12 denotes the welded portion of the end portion 13 of the first tube-like body 10″, reference number m13 denotes the welded portion of the end portion 14 of the first tube-like body 10″, reference number m22 denotes the welded portion of the end portion 23 of the second tube-like body 20″, and reference number m23 denotes the welded portion of the end portion 24 of the second tube-like body 20″.

According to the method of manufacturing the blood-pressure cuff 100 of the above-described embodiment, the two bags 10′, 20′ in which the insides thereof communicate with each other are joined as the fluid bag 50 in which the two fluid rooms communicate with each other, and these bags 10′, 20′ are manufactured by the two members such as the first member 10 and the second member 20. Therefore, the blood-pressure cuff 100 can be manufactured with a simple process without processing many complex components like a conventional fluid bag.

More specifically, the two members (the first and second members 10, 20) which become the bags (the first and second bags 10′, 20′) later are overlapped, and are joined in a region having an area smaller than an area of the overlapped region. Thereby, both of the bags 10′, 20′ constitute the integrated fluid bag 50 in a state in which both of the members 10, 20 are formed into the bag 10′, 20′, respectively, and the insides of the bags 10′, 20′ are used as fluid rooms, respectively, in the fluid bag 50.

The opening W having on the circumferential portion the welded portion M functions as a portion which communicates the insides of both bags 10′, 20′ (fluid rooms) in a state formed in the fluid bag 50. However, the circumferential portion of the opening W is joined by the welded portion M, so that air and the like supplied inside the fluid bag 50 does not leak outside the fluid bag 50 from the circumferential portion of the opening W.

The process which joins both members 10, 20 and the process which forms the opening W are performed before forming both members 10, 20 into the bags 10′, 20′, so that these processes can be easily performed.

The first and second members 10, 20 are simple sheet-like members, and are not complex components. Therefore, the processes for these members 10, 20 can be easily conducted, and the material costs can be lowered.

When forming the first member 10 into the bag 10′, the opposite side portions 11, 12 of the first sheet-like member 10 are overlapped such that the face which becomes the inside face of the tube-like body faces the face which becomes the outside face of the tube-like body, and the overlapped opposite side portions 11, 12 are joined to form the first tube-like body 10″. Then, both of the end portions 13, 14 of the first tube-like body 10″ in the axis direction are deformed to be crushed in the radial direction of the tube-like body, respectively, and the side portions are overlapped such that the inside faces of the tube-like body face each other, and the overlapped end portions 13, 14 are joined, respectively, to close the openings of both end portions 13, 14 of the first tube-like body 10″. Therefore, the first bag 10′ is formed, and the bag 10′ in which the inside portion becomes a fluid room can be formed by a simple process.

Similarly, when forming the second member 20 into the second bag 20′, the opposite sides 21, 22 of the second sheet-like member 20 are overlapped such that the face which becomes the inside face of the tube-like body faces the face which becomes the outside face of the tube-like body, and the overlapped opposite side portions 21, 22 are joined to form the second tube-like body 20″. Then, both of the end portions 23, 24 of the second tube-like body 20″ in the axis direction are deformed to be crushed in the radial direction of the tube-like body, respectively, and the side portions are overlapped such that the inside faces of the tube-like body face each other, and the overlapped end portions 23, 24 are joined, respectively, to close the openings of both end portions 23, 24 of the second tube-like body 20″. Therefore, the second bag 20′ is formed, and the bag 20′ in which the inside portion becomes a fluid room can be formed by a simple process.

As for the first bag 10′ and the second bag 20′, when forming the sheet-like members 10, 20 into the tube-like bodies 10″, 20″, the side portion 11 and the side portion 12 are joined such that the face which becomes the inside face of the tube-like body faces the face which becomes the outside face of the tube-like body in a position except for regions corresponding to folding line portions 15, 16 (FIG. 3B) when both end portions 13, 14 of the tube-like body 10″ in the axis direction (y-axis direction) are deformed to be crushed, and the side portion 21 and the side portion 23 are joined such that the face which becomes the inside face of the tube-like body faces the face which becomes the outside face of the tube-like body in a position except for regions corresponding to folding line portions 25, 26 when both end portions 23, 24 of the tube-like body 20″ in the axis direction (y-axis direction) are deformed to be crushed. Therefore each of the bags 10′, 20′ can be downsized.

Namely, the folding line portions 15, 16, 25, 26 correspond to the end edges in the width direction (x-axis direction) when the bags 10′, 20′ are contracted.

In this case, in the end edge, if the faces which become the inside faces of the fluid bag are joined to face each other, the portion where the inside faces face each other is not filled up with air if air is supplied inside the fluid bag. Therefore, the joined portion does not expand, and the joined portion of the fluid bag does not expand.

Regarding the conventional fluid bag, the joined portion of the end edge in the width direction does not expand and contract, so that the width which contributes to the expansion and contraction is reduced by the width of the substantial joined portion. Namely, the width of the joined portion is wasted.

Moreover, if the side portions are joined such that the face which becomes the inside face of the tube-like body faces the face which becomes the outside face of the tube-like body, the portion where the side portions are overlapped to be welded has an increased thickness compared to another portion. As a result, if the welded portions m11, m21 (joined portions) are located in the end edges of the width direction, which become the folding line portions in the contracting of the fluid bag, the folding line portions are not smoothly folded in the contracting by the influence of the increased rigidity of the welded portions m11, m12, and the thickness of the fluid bag 50 in the end edges of the width direction in the contracted state can not be reduced as intended.

On the other hand, in the present embodiment (another embodiment and modified examples) in which the welded portions m11, m21 are not located in the end edges of the width direction, the welded portions m11, m21 are not located in the end edges of the width direction, so that the fluid bag 50 can be downsized, and the compact cuff 100 can be manufactured.

If the tube-like body is formed by welding the faces which become the inside faces of the fluid bag to face each other, even if the welded position is freely selected, the welded portion projects outside the fluid bag, so that the thickness and the width of the fluid bag are increased by the projection.

Consequently, by welding the face which becomes the inside face of the tube-like body and the face which becomes the outside face of the tube-like body to face each other, the welded portion can be prevented from projecting outside the fluid bag, and the increase in the thickness and the width of the fluid bag can be prevented.

According to the manufacturing method of the present embodiment, when the end portions 13, 14 of the first tube-like body 10″ of the first sheet-like member 10 and the end portions 23, 24 of the second tube-like body 20″ of the second sheet member 20 are crushed in the radial direction of the tube-like body, respectively, the end portions are crushed by being pressed in the direction orthogonal to the plane where the opening W extends (the x-y plane of coordinates prescribed by the x-axis and the y-axis). For this reason, the welded portions m12, m13, m22, m23 each having rigidity increased by the welding extend in the plane of the opening W (the joined portion in each end portion 13, 14, 23, 24 extends in the x-axis direction). Therefore, the height in the contracted state of each bag 10′, 20′ (the thickness of the cuff 100 (the thickness of the z-axis direction)) can be reduced.

### Modified Example 1

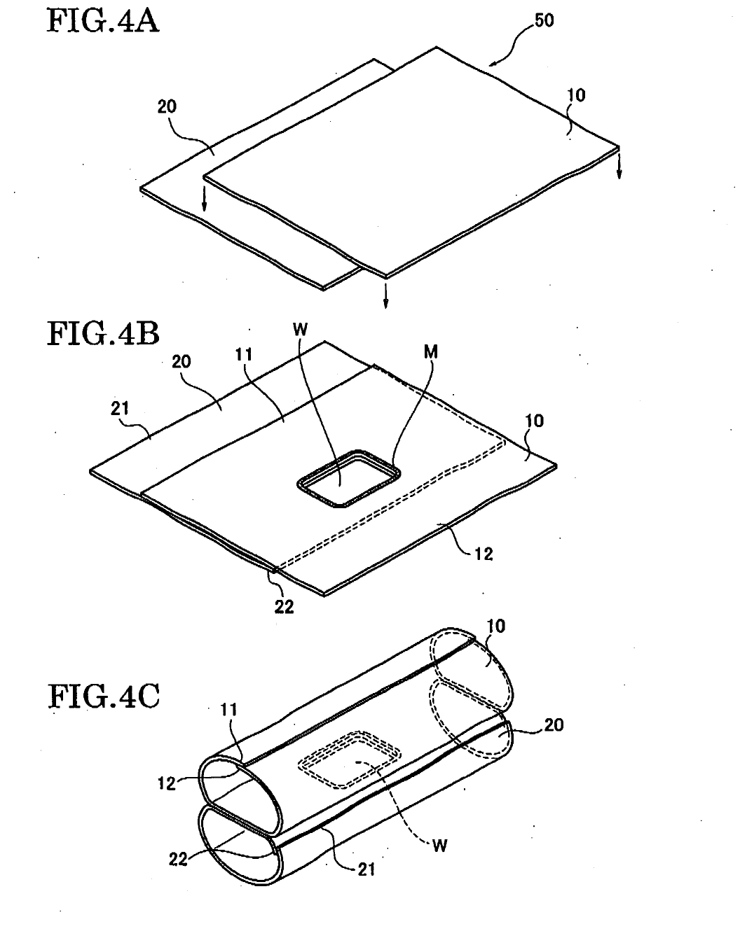

The manufacturing method described in the above Embodiment 1 is not limited to the method which completely overlaps both of the sheet members 10, 20 as illustrated in FIG. 2A. For example, both of the sheet members 10, 20 can be overlapped in a state in which both of the sheet members 10, 20 are intentionally displaced as illustrated in FIG. 4A.

Then, both of the sheet-like members 10, 20 are welded as illustrated in FIG. 4B. It is preferable for the opening W to be located in a position close to one side portion (for example, the side portion 22 in FIG. 45) of the opposite sides 21, 22 of the second sheet-like member 20.

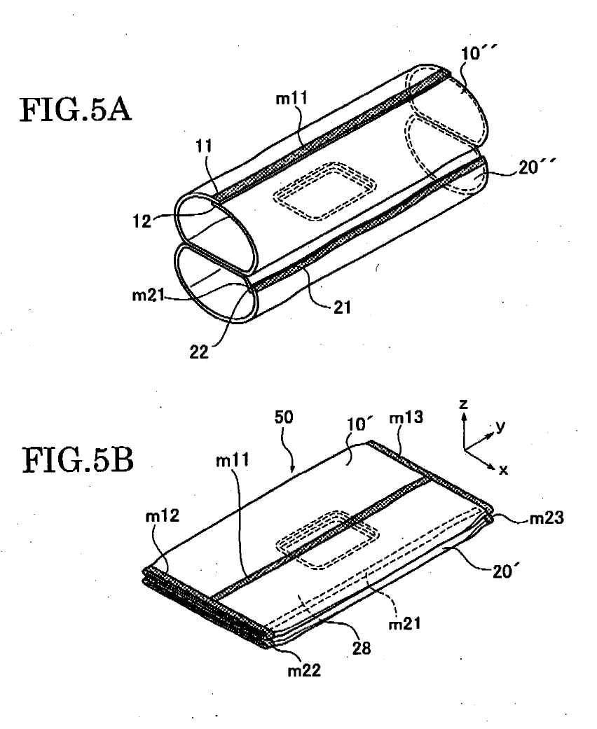

Namely, in the manufacturing method of the above Embodiment 1, the welded portion M and the opening W in the second sheet-like member 20 which is located on the side (inner circumferential side) close to the measurement portion of the subject 200 in the sheet-like members 10, 20 are formed in a position which is not in the center between the opposite sides 21, 22 and is close to one side portion 22. Therefore, when forming the second tube-like body 20″, the welded portion m21 (refer to FIGS. 5A, 5B) in which the overlapped opposite side portions 21, 22 (FIG. 4C) are welded is formed in a region facing the first bag 10′, which is located on the far side of the subject 200, in the second bag 20′.

As a result, the welded portion m21 having a rigidity increased by welding double sheets (the opposite side portion 21 and the opposite side portion 22 are overlapped) does not exist in a plane (the lower plane in FIG. 58) facing the measurement portion of the subject 200 in the second bag 20′ closer to the subject 200. Therefore, the propagation of the pulse wave is not disturbed by the welded portion m21, so that the deterioration in the detection accuracy of the pulse wave signal can be prevented, and also the measurement portion of the subject 200 can be uniformly pressed.

Additionally, the feeling of the welded portion m21 hardly reaches the subject 200 wrapped by the cuff 100. As a result, the uncomfortable feeling to the subject 200 can be lowered compared to the fluid bag 50 of Embodiment 1 illustrated in FIGS. 2, 3 in which the feeling of the welded portion m21 easily reaches the subject 200.

### Modified Example 2

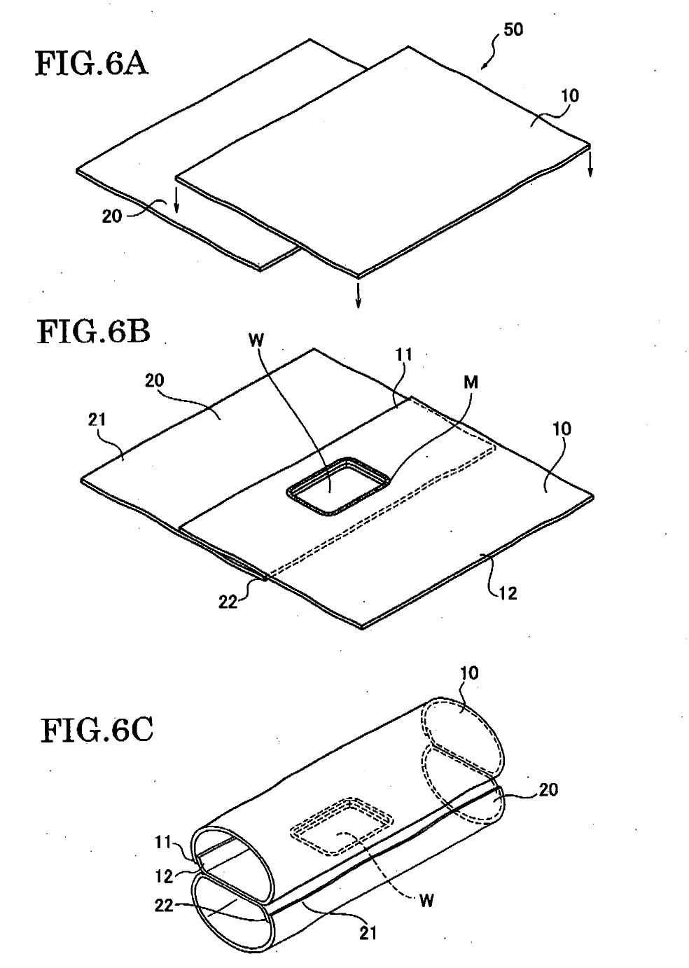

In the above described manufacturing method according to Modified Example 1, as illustrated in FIGS. 4, 5, the displacement amount between both of the sheet-like members 10, 20 is relatively small, and the welded portion M and the opening W are formed in the substantial center between the opposite side portions 11, 12 in the first sheet-like member 10. However, by further increasing the displacement amount between both of the sheet-like members 10, 20 (refer to FIG. 6A), the welded portion M and the opening W can be formed in a portion closer to the side portion 11 (refer to FIG. 6B) in the direction opposite to the second sheet-like member 20 in the first sheet member 10.

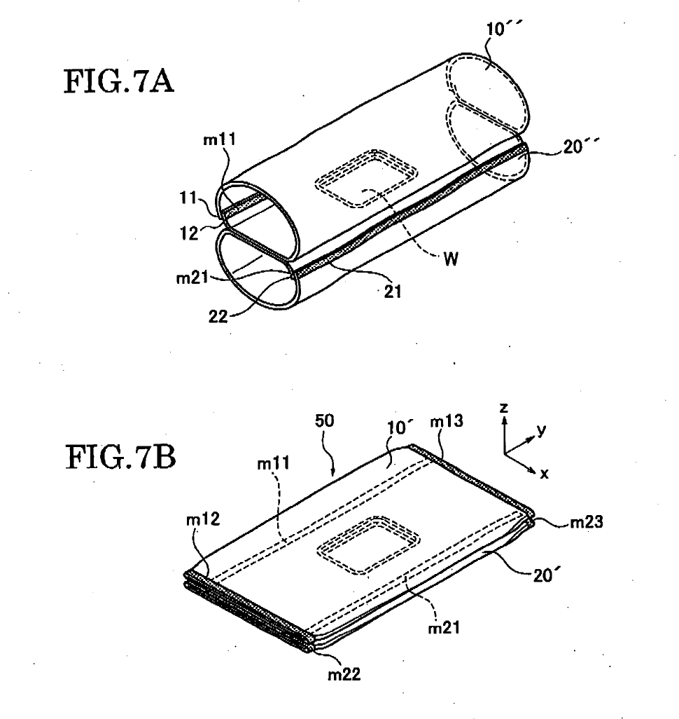

As described above, by largely reducing the area of the overlapped portion of the sheet-like members 10, 20, and displacing the positions of the welded portion M and the opening W from the central portions of the sheet-like members 10, 20 in the directions opposite to each other, the position which overlaps the opposite sides 11, 12 of the first sheet-like member 10 is displaced to the position facing the second bag 20′ in a state in which the first bag 10′ is formed (refer to FIG. 7B). As a result, the welded portion m11 which welds the overlapped portion of the opposite sides 11, 12 is displaced from the center of the width direction of the first bag 10′ as illustrated in FIGS. 7A, 7B.

In this case, the fluid bag 50 is provided with a connector to which an air hose 90 for supplying air and the like inside the fluid bag 50 is connected. However, by forming the welded portion m11 in the position displaced from the center of the width direction of the first bag 10′ as described above, the welded portion m11 and the attachment portion of the connector in the fluid bag 50 can be separated from each other, so that it is unnecessary to definitely adjust the positional relationship of tools and the like for use in the attachment process of the connector and the welding process, and also an additional operation such as adjustment of the inclination of the connector and the like which is required for attaching the connector to the welded portion m11 is not necessary. Thus, the process operations can be easily performed.

In a state in which the tube-like bodies 10″, 20″ are formed into the bag 10′, 20′, the welded portion m11 in the first tube-like body 10″ is located in a position which does not overlaps with the welded portion m21 of the second tube-like body 20″.

In this case, the thickness of each welded portion m11, m21 is larger than the thickness of the portions except for the welded portions m11, m21 because each sheet-like member 10, 20 is stacked in pairs in order to form each tube-like portion 10″, 20″.

For this reason, if the welded portion m11 of the first bag 10′ and the welded portion m21 of the second bag 20′ are formed in a position which overlaps the welded portion m 11 and the welded portion m21 in a state in which the fluid bag 50 is contracted, the thickness in that position is increased.

On the other hand, in the manufacturing method which forms the welded portion m11 of the first bag 10′ and the welded portion m21 of the second bag 20′ in positions which do not overlap each other in the above Embodiment 1, it is possible to prevent the increase in the thickness from concentrating in one place; thus, the increase in the thickness of the entire cuff 100 can be reduced.

### Modified Example 3

In each of Embodiment 1 and Modified Examples 1, 2, the first bag 10′ and the second bag 20′ are formed from the sheet-like members 10, 20, respectively. However, the method of manufacturing a blood-pressure cuff according to the present invention is not limited thereto. A member which is previously formed into a tube-like body can be applied as the first member 10 and the second member 20.

More specifically, the first member 10 which becomes the first bag 10′ can be a sheet-like member or a tube-like member. When a sheet-like member is applied as the first member 10, after forming this sheet-like member 10 (first member) into the tube-like body 10″ as described in Embodiment 1 and Modified Examples 1, 2, the tube-like body 10″ is formed into the first bag 10′. When the tube-like body is applied as the first member 10, this tube-like body 10 (first member) is formed into the first bag 10′. This is similar to the second member 20 which becomes the second bag 20′.

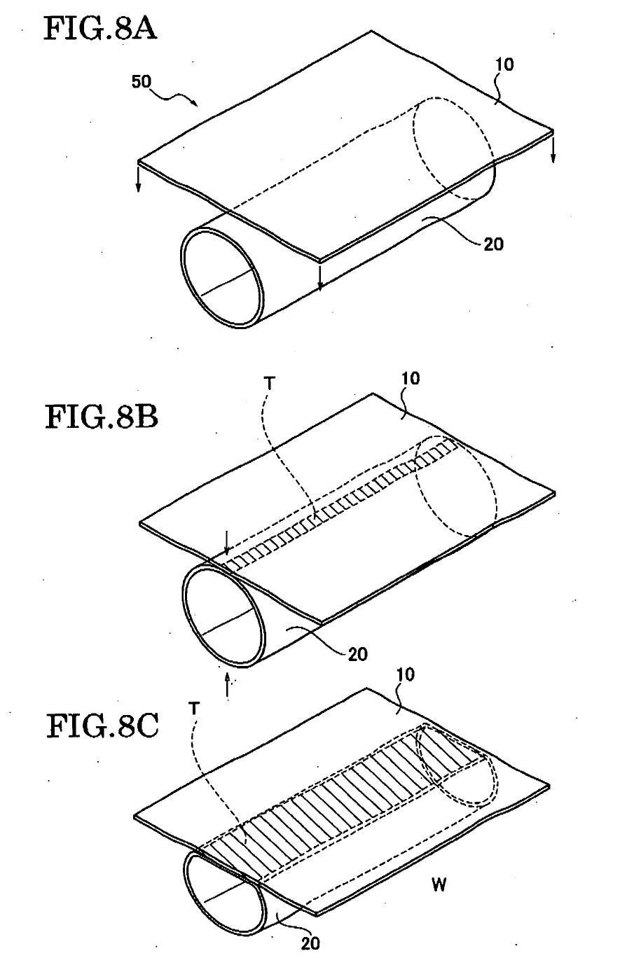

For example, in Modified Examples 2, 3, as illustrated in FIG. 8A, the sheet-like member is used as the first member 10, and the tube-like body is used as the second member 20. The first member 10 which is the sheet-like member is overlapped with the circumferential surface of the second member 20 which is the tube-like body (refer to FIG. 8B). In this case, an area T where both of the members 10, 20 are overlapped is a linear shape.

The overlapped members 10, 20 are pressed in the overlapping direction of both members 10, 20, so that the tube-like body which is the second member 20 is deformed. Thereby, the region T where the circumferential surface of the tube-like body of the second member 20 has contact with the surface of the sheet-like member of the first member 10 is expanded in a plane form (refer to FIG. 8C).

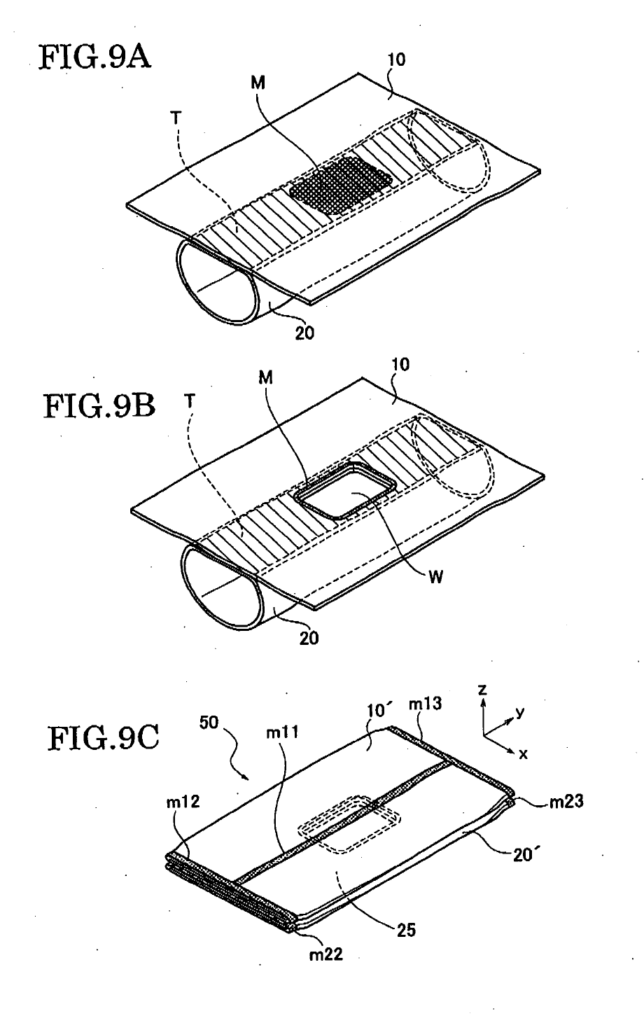

The region T where both of the members 10, 20 have contact with each other is adopted as a region where both of the members 10, 20 are overlapped. After that, similar to Embodiment 1 and Modified Examples 1, 2, these two members 10, 20 are joined by means of welding and the like (welded portion M in FIG. 9A) in a region having an area which is smaller than the overlapped area T (refer to FIG. 8C), and the range surrounded by the entire portion or a part of the joined portion M is cut out, and the opening W which is common to the two members 10, 20 is formed (refer to FIG. 9B). After forming the first member 10 which is a sheet-like member into a tube-like body similar to Embodiment 1, the first member 10 is formed into the first bag 10′ and the second member 20 which is a tube-like body is formed in the second bag 20′ (refer to FIG. 9C), so that the fluid bag 50 in which the first bag 10′ and the second bag 20′ are joined can be formed.

In this example, as illustrated in FIG. 9A, the welded portion M is one rectangular region, and as illustrated in FIG. 9B, the opening W is formed by cutting out a range surrounded by the outside portion of the welded portion M which is a part of the welded portion M. However, as described in the above Embodiment 1 and Modified Examples 1, 2, the circumferential area of the opening W can be only welded (the welded portion M is a closed ring-like rectangle), and the opening W can be formed by cutting out the range surrounded by the welded portion M.

The tubular body as the second member 20 in Modified Example 3 can be formed by joining the opposite sides of the sheet-like member similar to the sheet like member as the first member 10 such that the face which becomes the inner face of the tubular body faces the face which becomes the outer face of the tubular body, or can be formed by means of extrusion molding, injection molding and the like to be a tubular shape from the beginning, or can be formed as a tubular body without having the welded portion m21. The cutting out of such an opening W can be applied to another embodiment or another modified example.

### Embodiment 2

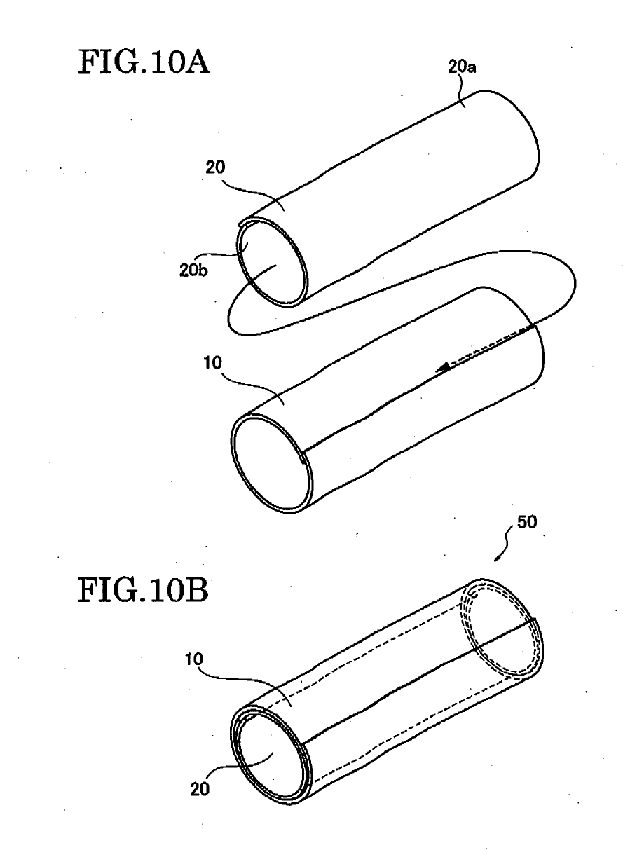

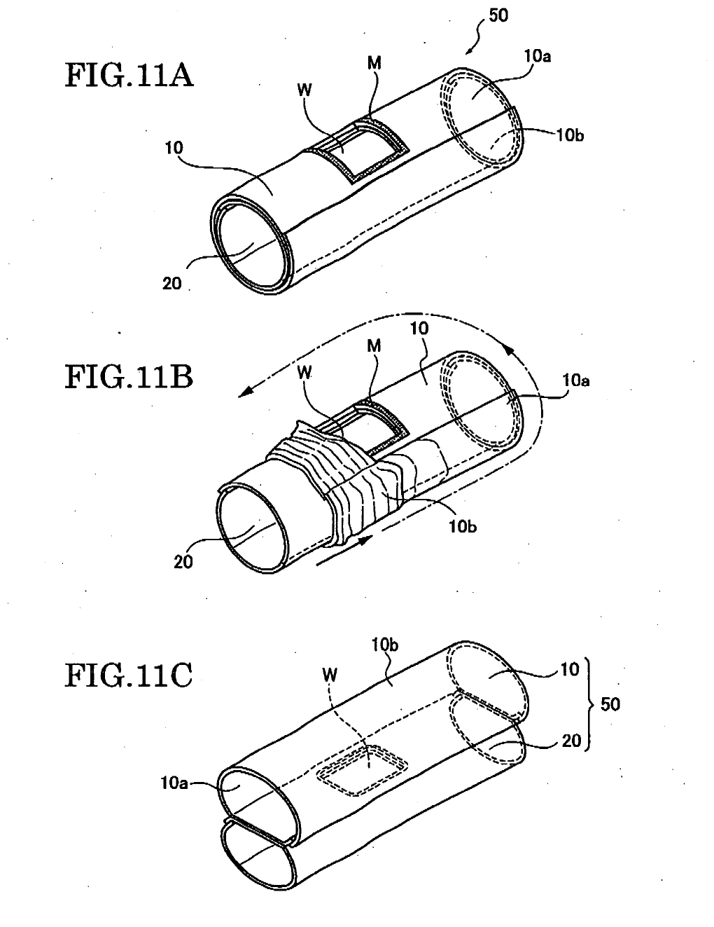

FIGS. 10, 11 are views each illustrating Embodiment 2 of a method of manufacturing a blood-pressure cuff according to the present invention. In this manufacturing method of Embodiment 2, the two members (the first and second members 10, 20) which become the bags 10′, 20′ later are previously joined, and the opening W which communicates both of the bags 10′, 20″ with each other when formed into the bags 10′, 20′ later is formed in the joined portion. After that, both of the members 10, 20 are formed as the bags 10′, 20′, respectively, so that the single fluid bag 50 in which the two fluid rooms (inside space in each bag) communicate with each other can be obtained.

More specifically, as illustrated in FIG. 10A, in the method of manufacturing the cuff 100 according to the present embodiment, at first, one of the tube-like members 10, which become the first and bags 10′, 20′, later, respectively, is inserted into the other of the tube-like members, so as to form double tube-like bodies (refer to FIG. 10B).

In this example, the second member 20 is inserted into the first member 10, but the first member 10 can be inserted into the second member 20.

The circumferential surfaces of both the members 10, 20 are overlapped to have contact with each other as a region having planar expansion, and the two members 10, 20 are welded in a region (for example, a rectangular region in the central portion of the first member 10 and the second member 20) having an area (an area smaller than the area of the first member 10 or the area of the second member 20) smaller than the overlapped area (refer to FIG. 11A).

The portion illustrated by minute dots in the figures is the welded portion M. The welded portion M is a portion welded by heat and the like, but this portion can be joined by means of an adhesive material and the like instead of using the welding.

Then, the opening W which is common to the two members 10, 20 is formed by cutting out a region surrounded by the welded portion M (refer to FIG. 11A).

Next, prior to forming the first and second members 10, 20 into the corresponding bags 10′, 20′, respectively, as illustrated in FIG. 11B, the tube-like body (first member 10) which is located outside of the double tube-like bodies is pulled out from the inside tube-like body (second member 20) while being turned inside out from one end portion.

In this case, regarding the outside tube-like body (first member 10) after being pulled out from the inside tube-like body (second member 20) while being turned inside out, the front face 10a in the state of the double tube-like bodies (refer to FIG. 11A) becomes the back face 10b, and the back face 10b in the state of the double tube-like bodies (refer to FIG. 11A) becomes the front face 10a as illustrated in FIG. 11C.

As described above, regarding the two tube-like bodies (the first and second members 10, 20) which are joined to communicate with each other via the opening W, both end portions of each tube-like body in the axis direction are deformed to be crushed in the radial direction of the tube-like body, and are overlapped. The overlapped end portions are joined and the openings of both end portions of each tube-like body are closed so as to form the bag. Therefore, the fluid bag 50 in which the two bags are joined can be formed similar to Embodiment 1 and Modified Examples 1-3.

The fluid bag 50 obtained in the manufacturing process in Embodiment 2 is different from the fluid bags 50 obtained in Embodiment 1 and Modified Examples 1-3 in that the first member 10 which is the outside tube-like body of the double tube-like bodies is turned inside out from the first state (tube-like body before joining). However, the function of the obtained fluid bag 50 is the same as the function of the fluid bags 50 obtained in Embodiment 1 and Modified Examples 1-3.

As described above, according to the method of manufacturing the blood-pressure cuff 100 of the present embodiment, the fluid bag 50 in which the two fluid rooms communicate with each other is provided in a configuration in which the two bags which communicate with each other are joined. These bags are manufactured by the two members such as the first tube-like member 10 and the second tube-like member 20. Consequently, the blood-pressure cuff 100 can be manufactured with a simple process without processing many complex components like a conventional fluid bag.

Namely, by overlapping the two tube-like bodies (the first and second members 10, 20) which become the bags (the first and second bags) later, so as to join in a region having an area which is smaller than the overlapped area, both of the bags constitute the integrated fluid bag 50 in a state in which both of the members 10, 20 are formed in the bags, respectively, and the inside of each bag functions as a fluid room in the fluid bag 50.

The opening W having on the circumferential portion the joined region functions as a portion which communicates the insides (fluid rooms) of both bags with each other in a state formed into the fluid bag 50. However, the circumferential portion of the opening W is joined by the welded portion M, so that air and the like supplied inside the fluid bag 50 do not leak outside the fluid bag 50 from the circumferential portion of the opening W.

The process of joining both of the members 10, 20 and the process of forming the opening W are performed prior to forming both of the members 10, 20 into the bags, so that these processes can be easily conducted.

The first member 10 and the second member 20 are tube-like members each having a substantially cylindrical shape. Since the shapes of these components are not complex, the process for these members 10, 20 can be easily conducted, and the material costs can be lowered.

When forming the first member 10 into the first bag, both end portions of the tube-like body in the axis direction are deformed to be crushed in the radial direction of the tube-like body, and the side portions are overlapped. Then, the overlapped end portions are joined, respectively, and the first bag is formed by closing the openings of both end portions. Therefore, the bag having inside thereof a fluid room can be formed with a simple process.

Similarly, when forming the second member 20 into the second bag, both end portions of the tube-like body in the axis direction are deformed to be crushed in the radial direction of the tube-like body, and the side portions are overlapped. The overlapped end portions are joined, respectively, and the second bag is formed by closing the openings of both end portions. Therefore, the bag having inside thereof a fluid room can be formed with a simple process.

As for the first bag and the second bag, the folding line portions (refer to FIG. 3B) when deforming the first member 10 and the second member 20 of the tube-like bodies contribute to the expansion and contraction of the fluid bag. Thus, the width of each bag (the length along the x-axis direction) can be effectively used.

Therefore, according to the manufacturing method of the present embodiment, the width of the cuff 100 can be further reduced similar to Embodiment 1.

### Modified Example 4

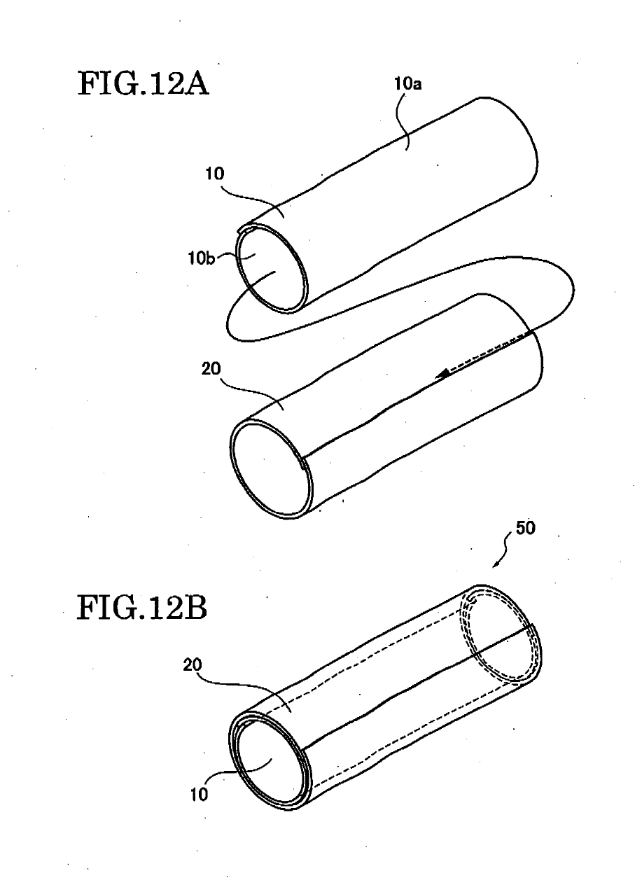

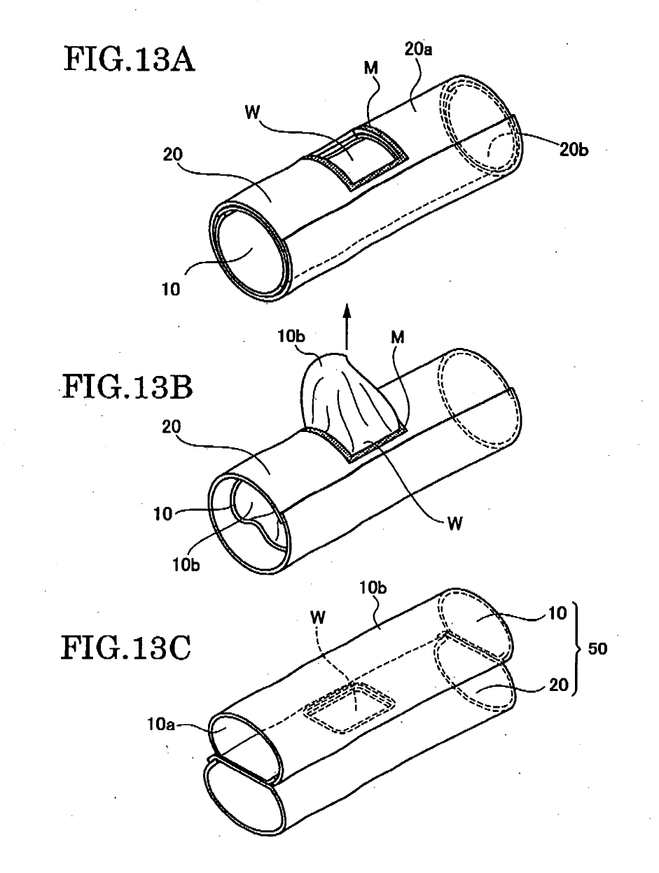

FIGS. 12, 13 are views each illustrating the modified example of the above Embodiment 2. In the method of manufacturing a blood-pressure cuff according to Embodiment 2, the outside tube-like body (first member 10) of the double tube-like bodies is pulled out from the inside tube-like body (second member 20) while being turned inside out from one end portion. However, the process of pulling out one of the double tube-like bodies is not limited to the process illustrated in Embodiment 2.

Namely, as the modified example of Embodiment 2 illustrating the method of manufacturing a blood-pressure cuff, one of the tube-like first and second members 10, 20 which become the first and second bags 20′ is inserted inside the other of the tube-like first and second members 10, 20, as illustrated in FIG. 12A, so as to form the double tube-like bodies (refer to FIG. 12 B).

In this example, the first member 10 is inserted inside the second member 20, but the second member 20 can be inserted inside the first member 10.

Then, the circumferential surfaces of both the members 10, 20 are overlapped to have contact with each other as a region having a plane-like expansion. The two members 10, 20 are welded in a region (a rectangular region in the central portion of the first member 10 and the second member 20) having an area smaller than the overlapped area (an area smaller than the area of the first member 10 or the area of the second member 20) (refer to FIG. 13A).

The portion illustrated by the fine dots in the figures is the welded portion M. The welded portion M is welded by heat and the like. However, instead of using the welding process, the joining process by means of an adhesive material and the like may be applied.

Then, the opening W which is common to the two members 10, 20 is formed by cutting out a range surrounded by the welded portion M (refer to FIG. 13A).

Next, prior to forming the first and second members 10, 20 into the bags 10′, 20′, as illustrated in FIG. 13B, the inside tube-like body (first member 10) of the double tube-like bodies is pulled out from the outside tube-like body (second member 20) while being turned inside out through the opening W.

In this case, regarding the inside tube-like body (first member 10) after being pulled out from the outside tube-like body (second member 20) while being turned inside out, as illustrated in FIG. 13C, the front face 10a in the state of the double tube-like bodies (FIG. 13A) becomes the back face 10b, and the back face 10b in the state of the double tube-like bodies (FIG. 13A) becomes the front face 10a.

Regarding the two tube-like bodies 10, 20 which are joined and communicate with each other via the opening W as described above, similar to Embodiment 1, Modified Examples 1-3, and Embodiment 2, both end portions of each tube-like body in the axis direction are deformed to be crushed in the radial direction of the tube-like body such that the side portions are overlapped, and the bags are formed by joining the overlapped end portions to close the openings of both end portions of each tube-like body. Consequently, the fluid bag 50 in which two bags are joined can be obtained similar to Embodiments 1, 2, and Modified Examples 1-3.

According to the method of manufacturing the blood-pressure cuff 100 in the above described Modified Example 4, the functions and the effects similar to those in Embodiment 2 can be obtained.

According to the embodiments of the present invention, the method of manufacturing a blood-pressure cuff having the fluid bag which expands in a state in which fluid is supplied inside and contracts in a state in which the fluid is removed, the blood-pressure cuff being wrapped around a subject, includes the steps of: overlapping the first member which becomes the first bag and the second member which becomes the second bag; joining (welding and joining capable of ensuring an air sealing performance such as adhesive bonding, hereinafter the same) the two members in a region having an area smaller than an area of the overlapped region; forming the opening which is common to the two members by cutting out a range surrounded by an entire portion or a part of the joined region; and forming the fluid bag in which the first bag and the second bag are joined by forming the first member into the first bag and the second member into the second bag.

In this case, the overlapped region means not only a region (for example, when the two members are sheet-like members, a region in which both of the members have contact with each other in a natural state becomes a plane-like region) where both of the members have contact with each together in a simply overlapped natural state (a state in which a load besides gravity does not act), but also a region where both of the members have contact with each other in a state in which a pressing force acts on both the overlapped members in the overlapped direction (for example, when one member is a tube-like body and the other member is a sheet-like member, in a state in which the pressing force acts on both members in the overlapped direction, the tube-like body is deformed to a flat form by the pressing force, and the region where both members have contact with each other becomes a rectangular plate-like region).

When forming the opening, if the circumferential portion of the opening is only joined (the joined region becomes a closed ring-like form), only a range surrounded by the entire portion of the joined region is cut out. On the other hand, if not only the circumferential portion of the opening but also the entire region of one region is joined (the joined region becomes a plane-like form such as a rectangular and circularity), a region (the inside portion except the outside portion in the plane-like region) surrounded by a part of the joined region (the outside portion which is a part of the plane-like region although the entire portion of the joined region is a plane-like form) is cut out.

In addition, the step of joining the region where both of the members are overlapped is performed before the step of cutting out the range surrounded by a part or the entire portion of the joined region. However the cutting out step can be performed before the joining step.

According to the method of manufacturing a blood-pressure cuff as described above, the fluid bag in which the two fluid rooms communicate with each other is provided in a state in which the two bags are joined, and these bags are manufactured by the two members such as the first member and the second member. Therefore, without processing many complex components as a conventional fluid bag, the blood-pressure cuff can be manufactured with a simple process.

Namely, by overlapping the two members which later become the bags (the first and second bags), and joining a region having an area smaller than the area of the overlapped region, both of the bags constitute the integrated fluid bag in a state in which both of the members are formed in the bags later, and the inside portions of the two bags function as the two fluid rooms in the fluid bag.

The opening surrounded by the joined region is used as a portion which communicates the inside portions (fluid rooms) of both of the members with each other in a state formed in the fluid bags. However, the circumferential portion of the opening is joined, so that the fluid supplied inside the fluid bag does not leak outside the fluid bag from the circumferential portion of the opening.

By performing the steps of joining both of the members and forming the opening before forming both of the members into the bags, these steps can be easily performed.

In the method of manufacturing a blood-pressure cuff as described above, a connector (joint) which is a component for connecting a tube for fluid (for example, an air hose), which supplies the fluid inside the fluid bag and squirts the supplied fluid outside the fluid bag, is not described. The connector is attached to at least one member of the first and second members, and the connector can be attached to the one member any time if it is attached to the one member before both of the members are formed into the bags, and it can be attached to the one member before the first and second members are joined and after the first and second members are joined.

According to the method of manufacturing a blood-pressure cuff as described above, the blood-pressure cuff can be manufactured with a simple process without processing many of complex components as a conventional fluid bag.

Although the embodiments of the present invention have been described above, the present invention is not limited thereto. It should be appreciated that variations may be made in the embodiments described by persons skilled in the art without departing from the scope of the present invention.

What is claimed is:

1. A method of manufacturing a blood-pressure cuff having a fluid bag which expands in a state in which fluid is supplied inside and contracts in a state in which the fluid is removed, the blood-pressure cuff being wound around a subject, comprising the steps of:
overlapping a first member which becomes a first bag and a second member which becomes a second bag;
joining the two members in a region having an area smaller than an area of the overlapped region;
forming an opening which is common to the two members by cutting out a range surrounded by an entire portion or a part of the joined region; and
forming the fluid bag in which the first bag and the second bag are joined by forming the first member into the first bag and the second member into the second bag.

2. The method of manufacturing a blood-pressure cuff according to claim 1, wherein
the first member is an approximate rectangular sheet-like member and the second member is an approximate rectangular sheet-like member,
when forming the first member into the first bag, opposite sides of the first sheet-like member as the first member are overlapped, a first tube-like body is formed by joining the overlapped opposite sides, both end portions of the first tube-like body in the axis direction are overlapped by deforming to be crushed in the radial direction of the tube-like body, and the first bag is formed by joining the overlapped end portions to close openings of both end portions of the first tube-like body, and
when forming the second member into the second bag, opposite sides of the second sheet-like member as the second member are overlapped, a second tube-like body is formed by joining the overlapped opposite sides, both end portions of the second tube-like body in the axis direction are overlapped by deforming to be crushed in the radial direction of the tube-like body, and the second bag is formed by joining the overlapped end portions to close openings of both end portions of the second tube-like body.

3. The method of manufacturing a blood-pressure cuff according to claim 2, wherein, regarding the bag of the two bags, which is located on a side close to the subject, when forming the sheet-like member into the tube-like body, the overlapped opposite sides are joined in a region facing the bag of the two bags, which is located far from the subject.

4. The method of manufacturing a blood-pressure cuff according to claim 2, wherein, when forming the sheet-like member into the tube-like body, the opposite sides are joined in a position except for a region corresponding to a folding line portion when deforming the both end portions of the tube-like body in the axis direction to be crushed.

5. The method of manufacturing a blood-pressure cuff according to claim 2, wherein, regarding the bag of the two bags, which is located on a side far from the subject, when forming the sheet-like member into the tube-like body, the overlapped opposite sides are joined in a position which does not overlap with a joined portion of the bag located on a side close to the subject, in a region facing the bag of the two bags, which is located on a side close to the subject.

6. The method of manufacturing a blood-pressure cuff according to claim 2, wherein when forming the sheet-like member into the tube-like body, the opposite sides are overlapped such that a face which becomes an inner face of the tube-like body faces a face which becomes an outer face of the tube-like body, and the overlapped opposite sides are joined.

7. The method of manufacturing a blood-pressure cuff according to claim 2, wherein when crushing both end portions of the two tube-like bodies, respectively, in the radial direction of the tube-like body, both end portions are crushed by being pressed in the direction orthogonal to a face in which the opening extends.

8. The method of manufacturing a blood-pressure cuff according to claim 1, wherein
one of the first and second members is an approximate rectangular sheet-like member, and the other of the first and second members is a tube-like body,
when forming the sheet-like member of the first and second members into the bag, one opposite sides of the sheet-like member is overlapped, a tube-like body is newly formed by joining the overlapped opposite sides, both end portions of the tube-like body in the axis direction are overlapped by deforming to be crushed in the radial direction of the tube-like body, respectively, and the bag is formed by joining the overlapped end portions to close openings of both end portions of the tube-like body, and
when forming the tube-like member of the first and second members into the bag, both end portions of the tube-like body in the axis direction are overlapped by deforming to be crushed in the radial direction of the tube-like body, and the bag is formed by joining the overlapped end portions to close openings of both end portions of the tube-like body.

9. The method of manufacturing a blood-pressure cuff according to claim 1, wherein
the first member is a tube-like body and the second member is a tube-like body,
when overlapping the first and second members, one of the tube-like bodies is inserted into the other of the tube-like bodies to form double tube-like bodies, and at least a part of circumferential faces of the tube-like bodies are overlapped,
prior to forming the first and second members into the corresponding bags, respectively, the inside tube-like body of the double tube bodies is pulled out from the outside tubular body through the opening while being turned inside out, or the outside tube-like body of the double tube-like bodies is pulled out from the inside tube-like body while being turned inside out from one end side,
when forming the first member into the first bag, both end portions of the first tube-like body as the first member in the axis direction are overlapped by deforming to be crushed in the radial direction of the tube-like body, and the first bag is formed by joining the overlapped end portions to close openings of both end portions of the first tube-like body, and
when forming the second member into the second bag, both end portions of the second tube-like body as the second member in the axis direction are overlapped by deforming to be crushed in the radial direction of the tube-like body, and the second bag is formed by joining the overlapped end portions to close openings of both end portions of the second tube-like body.
